(19) United States
(12) Patent Application Publication
(10) Pub. No.: US 2023/0271189 A1
(43) Pub. Date: Aug. 31, 2023

(54) THERMAL CYCLER COMPRISING DAMPING MODULE

(71) Applicant: SEEGENE, INC., Seoul (KR)

(72) Inventors: Jin Won KIM, Seoul (KR); Jin Seok NOH, Daejeon (KR); Dong Woo KANG, Seoul (KR)

(21) Appl. No.: 18/016,379

(22) PCT Filed: Jul. 28, 2021
(86) PCT No.: PCT/KR2021/009834

§ 371 Date: Jan. 16, 2023

(30) Foreign Application Priority Data
Jul. 31, 2020 (KR) 10-2020-0096253

(51) Int. Cl. B01L 7/00; B01L 3/00

(52) U.S. Cl. CPC B01L 7/52; B01L 3/502761; B01L 2200/025; B01L 2200/0663; B01L 2300/0627; B01L 2300/1805; B01L 2300/1822; B01L 2300/1827; B01L 2300/1844; B01L 2300/1894

(57) ABSTRACT

Provided a thermal cycler including a thermal block housing comprising a thermal block accommodating a reaction vessel and a temperature control portion for controlling a temperature of the thermal block, a support frame provided at the lower side of the thermal block housing, and at least one damping module comprising a fastening member coupled to the thermal block housing and the support frame and an elastic member provided between the thermal block housing and the support frame and elastically supporting the thermal block housing while spaced apart from the support frame.

### TECHNICAL FIELD

The present disclosure relates to a thermal cycler comprising damping module for nucleic acid reactions.

### BACKGROUND ART

A polynucleotide chain reaction (PCR), most widely used for nucleic acid amplification, includes repeated cycles of denaturation of double-stranded deoxyribonucleic acid (DNA), followed by oligonucleotide primer annealing to a DNA template and primer extension by a DNA polymerase (Mullis, et al., U.S. Pat. Nos. 4,683,195, 4,683,202, and 4,800,159; and Saiki, et al., (1985) Science 230, 1350-1354).

A general real-time polymerase chain reaction (PCR) device may include a thermal cycler at the lower portion in which the nucleic acid amplification reaction occurs, and an optics mechanism at the upper part to analyze or monitor the nucleic acid amplification reaction in real time.

The DNA denaturation is performed at about 95° C., and the annealing and primer extension are performed at a temperature lower than 95° C., i.e. a temperature ranging from 55° C. to 75° C. Thus, a thermal cycler performs the nucleic acid amplification reaction on samples accommodated in reaction vessels by repeatedly raising and lowering the temperatures of the reaction vessels included in a thermal block. Here, heat provided to the thermal block is generated by a heat-generating element, and the heat generated by the heat-generating element is discharged outwardly through a heat sink.

One or more thermal cyclers in which the nucleic acid amplification reaction occurs are provided, and the optics mechanism measures fluorescence generated from the reaction vessel in which the amplification reaction occurs by each thermal cycler.

That is, the optics mechanism may include a light source for irradiating excitation light to the top surface of the reaction vessel, a photodiode for detecting emission light from the sample solution and the like. For example, the optics mechanism is be provided so as to be driven up and down by a motor and be positioned adjacent to or spaced apart from the top surface of the reaction vessel.

At the structure of the PCR device according to the prior art, the optics mechanism is provided so as to be driven up and down by the motor and the like. The optics mechanism is positioned adjacent to or spaced apart from the top surface of the reaction vessel. The guide pin protruding from the lower portion of the optics mechanism is inserted into the bush of the housing accommodating the thermal block to align the light source of the optics mechanism and the reaction vessel.

A hot lid supported on the upper surface of the reaction vessel is provided at the lower portion of the optics mechanism, and as the optics mechanism is positioned adjacent to the reaction vessel, the hot lid presses the reaction vessel so that it may adhere to the thermal block and the heat may be applied from the hot lead to the reaction vessel.

The optics mechanism is provided with a spring and the like for elastically supporting the hot lead, so that the hot lead is in surface contact with the reaction vessel, and the reaction vessel may be uniformly pressurized.

However, according to the structure of the PCR device of the prior art, the abrasion of the guide pin or the bush occurs when the guide pin is inserted into the bush. This abrasion is accumulated as a number of the nucleic acid amplification reactions are performed, so that the light source and the reaction vessel are not accurately aligned. Accordingly, there is a problem in that there occurs an error in the optical path of the excitation light generated from the light source and the emission light from the sample solution, and it is difficult to perform a precise analysis.

In addition, since the hot lead presses the reaction vessel while the optics mechanism is lowered by the motor, the load applied to the reaction vessel becomes excessively large, and there is a problem in that the reaction vessel may be damaged.

In addition, as the hot lead is positioned between the light source and the reaction vessel, the hot lead may be elastically supported by the spring and obstruct the optical path, thereby deteriorating the measurement performance of the optics mechanism.

### DISCLOSURE OF INVENTION

### Technical Problem

As one aspect, the present disclosure may provide a damping module coupled to a support frame and a thermal block housing absorbing a portion of the pressure due to an optics mechanism, so that a reaction vessel accommodated in the thermal block housing may be not damaged by the optics mechanism that moves to contact the thermal block housing with a predetermined pressure.

As the other aspect, in order to reduce an abrasion of a guide pin and a bush, to make the reaction vessel be in exact surface contact with the hot lead, and to prevent the load of a hot lead from being concentrated on either side of the reaction vessel, the present disclosure may adjust the depth at which the fastening member is coupled to the lower frame, and adjust the thermal block housing to be horizontal.

As another aspect, the present disclosure may provide a sensor module that generates a signal when the distance between the thermal block housing and the support frame is less than or equal to a predetermined distance so that the hot lead included in the optics mechanism may control the amount of pressure applied to the reaction vessel.

As further another aspect, the present disclosure may provide a lower frame with an inclined surface for concentrating and rapidly discharging air supplied from a heat dissipation fan to a heat sink in order to improve heat dissipation performance.

### Solution to Problem

According to an aspect of the present disclosure, provided is a thermal cycler including a thermal block housing comprising a thermal block accommodating a reaction vessel and a temperature control portion for controlling a temperature of the thermal block, a support frame provided at the lower side of the thermal block housing, and at least one damping module comprising a fastening member coupled to the thermal block housing and the support frame and an elastic member provided between the thermal block housing and the support frame and elastically supporting the thermal block housing while spaced apart from the support frame.

### Advantageous Effects of Invention

The thermal cycler according to embodiments of the present disclosure includes a damping module coupled to a support frame and a thermal block housing for accommodating a reaction vessel and a thermal block, thereby providing a movable range of a up and down directions to the thermal block housing and minimizing an abrasion of a guide pin and a bush.

In addition, the thermal cycler according to embodiments of the present disclosure may adjust the depth at which the fastening member is coupled to the lower frame and adjust the thermal block housing to be horizontal, thereby reducing the abrasion of the guide pin and the bush, making the reaction vessel be in exact surface contact with the hot lead, and preventing the load from being concentrated on either side of the reaction vessel.

In addition, the thermal cycler according to embodiments of the present disclosure includes a sensor module that generates a signal when the distance between the thermal block housing and the support frame is less than or equal to a predetermined distance so that the hot lead included in the optics mechanism may control the amount of pressure applied to the reaction vessel.

In addition, the thermal cycler according to embodiments of the present disclosure provide a lower frame with an inclined surface for concentrating and rapidly discharging air supplied from a heat dissipation fan to a heat sink, thereby improving heat dissipation performance.

### BRIEF DESCRIPTION OF DRAWINGS

FIG. 1 is an exploded perspective view showing a thermal cycler according to an embodiment of the present disclosure.

FIGS. 2 and 3 are perspective views of a thermal cycler according to an embodiment of the present disclosure.

FIGS. 4 to 6 are cross-sectional views of a portion of a thermal cycler according to an embodiment of the present disclosure.

FIG. 7 is a perspective view of a thermal cycler according to an embodiment of the present disclosure.

### MODE FOR THE INVENTION

Hereinafter, the present disclosure will be described in detail with reference to the accompanying drawings.

In designating elements of the drawings by reference numerals, the same elements will be designated by the same reference numerals although they are shown in different drawings. Further, in the following description of the present disclosure, a detailed description of known functions and configurations incorporated herein will be omitted in the situation in which the subject matter of the present disclosure may be rendered rather unclear thereby.

In addition, terms, such as first, second, A, B, (a), (b) and the like may be used herein when describing components of the present disclosure. Each of these terminologies is not used to define an essence, order or sequence of a corresponding component but used merely to distinguish the corresponding component from other component(s). In the case that it is described that a certain structural element “is connected to”, “is coupled to”, or “is in contact with” another structural element, it should be interpreted that another structural element may “be connected to”, “be coupled to”, or “be in contact with” the structural elements as well as that the certain structural element is directly connected to or is in direct contact with another structural element.

Hereinafter, embodiments of the present disclosure will be described in detail with reference to the accompanying illustrative drawings so that a person having ordinary skill in the art to which the present disclosure relates could easily put the present disclosure into practice.

A variety of nucleic acid amplification reactions may be performed using a thermal cycler according to the present disclosure. For example, such a nucleic acid amplification reaction may be performed by polymerase chain reaction (PCR), ligase chain reaction (LCR; see Wiedmann M, et al., “Ligase chain reaction (LCR)-overview and applications,” PCR Methods and Applications 1994 Feb; 3(4):551-64), gap filling LCR (GLCR; see WO 90/01069, European Patent No. 439182, and WO 93/00447), Q-beta replicase amplification (Q-beta; see Cahill P, et al., Clin Chem., 37(9):1482-5(1991), U.S. Pat. No. 5,556,751), strand displacement amplification (SDA; see G T Walker, et al., Nucleic Acids Res. 20(7):16911696(1992), European Patent No. 497272), nucleic acid sequence-based amplification (NASBA; see Compton, J. Nature 350(6313):912(1991)), transcription-mediated amplification (TMA; see Hofmann WP, et al., J Clin Virol. 32(4):289-93(2005); U.S. Pat. No. 5,888,779), rolling circle amplification (RCA; see Hutchison C.A., et al., Proc. Natl Acad. Sci. USA. 102:1733217336(2005)), and the like.

In particular, the thermal cycler according to the present disclosure is useful for nucleic acid amplification reactions based on polymerase chain reactions. A variety of nucleic acid amplification methods based on polymerase chain reactions have been known in the art. For example, such nucleic acid amplification methods include quan-titative PCR, digital PCR, asymmetric PCR, reverse transcriptase PCR (RT-PCR), dif-ferential display PCR (DD-PCR), nested PCR, arbitrary priming PCR (AP-PCR), multiplex PCR, SNP genotyping PCR, and the like.

In a case in which a predetermined reaction is repeated or the repetition of a reaction occurs for a predetermine time interval, the term “cycle” as used herein refers to a single repeating unit.

For example, in the PCR, a single cycle refers to a reaction including heat denaturation of a nucleic acid, hybridization or annealing of the nucleic acid with a primer, and primer extension. In this case, a change in predetermined conditions is an increase in the number of repetitions, and the repeating unit in reactions, including a series of the above-described operations, is set to be a single cycle.

The thermal cycler of an embodiment includes a thermal block-housing complex. The thermal block-housing complex includes a thermal block accommodating unit in which a thermal block is accommodated and a thermal block housing inside which the thermal block accommodating unit is provided.

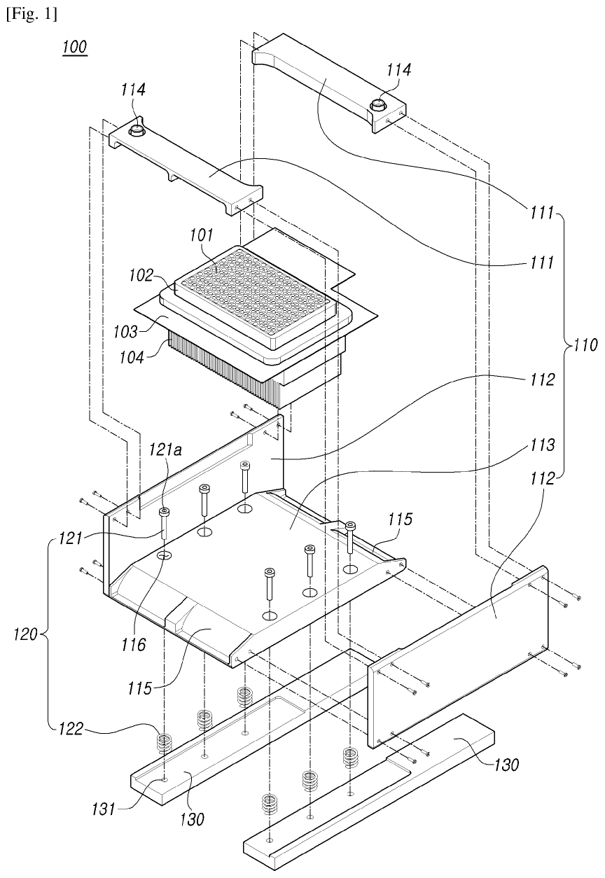

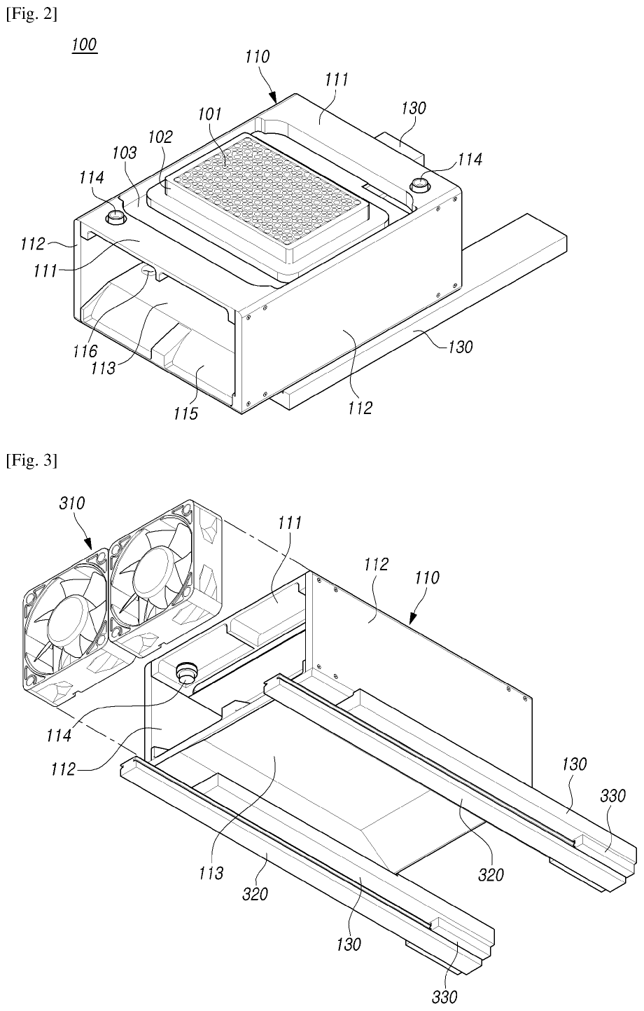

FIG. 1 is an exploded perspective view showing a thermal cycler according to an embodiment of the present disclosure. FIG. 2 is a perspective view of a thermal cycler according to an embodiment of the present disclosure.

Referring to FIGS. 1 and 2, a thermal block 101 accommodates a reaction vessel (not shown). The reaction vessel may be, for example, an individual tube, a vial, a strip to which a plurality of single tubes are connected, or a plate to which a plurality of tubes are connected. A sample solution is accommodated in the reaction vessel. A plurality of wells are formed in the thermal block 101 so that the reaction vessel may be inserted, and the reaction vessel is positioned in each well.

The thermal block 101 is accommodated in a thermal block accommodating unit 102. The thermal block accommodating unit 102 may be an open frame at upper and lower parts, and is supported on the side surface of the thermal block 101.

The thermal block 101 may be increased or decreased in temperature by a temperature control portion. The temperature control portion may include a heat generating element 103 and a heat sink 104.

The thermal block 101 may be increased or decreased in temperature by the heat generating element 103. The heat generating element 103 may include a peltier, a resistor, and the like. The heat generating element 103 is in contact with the thermal block 101 and regulates the temperature of the thermal block 101. The heat generating element 103 is disposed adjacent to and in contact with the thermal block 101, and may be disposed at the lower side of the thermal block 101.

The heat sink 104 dissipates heat from the heat generating element 103. The heat sink 104 may be made of metal or plastic, and may include a plurality of radiation fins to increase the heat dissipation area. The heat sink 104 is disposed adjacent to and in contact with the heat generating element 103, and may be disposed at the lower side of the heat generating element 103. Alternatively, the heat sink 104 dissipates heat from the thermal block 101. The heat sink 104 may be disposed adjacent to and in contact with the thermal block 101 and/or the heat generating element 103.

As the temperature of the thermal block 101 is controlled by the heating and cooling of the heat generating element 103, an amplification reaction is performed in the sample solution in the reaction vessel, and this amplification reaction is performed by an optics mechanism(not shown) is analyzed or monitored in real time.

The optics mechanism may include components such as a light source, a filter, a lens, a beam splitter, and a photodetector, and may detect fluorescence generated in a reaction vessel in real time according to an amplification reaction.

The optics mechanism is provided on the upper of the PCR device and the thermal cycler is provided on the lower of the PCR device, and the optics mechanism may be located on the upper of the thermal cycler, but is not limited thereto. All or some components of the optics mechanism may be provided to be moved up and down inside the PCR device by a driving device such as a motor. The optics mechanism may be lowered and positioned adjacent to the thermal block 101, and may be raised and positioned apart from the thermal block 101.

In order for excitation light generated from a light source of the optics mechanism to be guided to a corresponding reaction vessel, and emission light generated from a sample solution in the reaction vessel to be guided to a corresponding photodetector, the optics mechanism and the thermal block housing 110 are aligned and fixed with each other by a guide pin (not shown) and a bush 114 to be described later.

A hot lid may be provided at the lower side of the optics mechanism, and the hot lid is supported on the upper surface of the reaction vessel as the optics mechanism is lowered and positioned adjacent to the thermal block 101. Alternatively, the optical module of the optics mechanism is fixed and only the hot lead is lowered and is supported on the upper surface of the reaction vessel as it is positioned adjacent to the thermal block 101.

The hot lid may press the reaction vessel downward while supporting the upper surface of the reaction vessel. Accordingly, the reaction vessel is in close contact with the thermal block 101, and heat transfer efficiency is increased. The hot lead includes a heat generating element. For example, the hot lead may be provided with a heat-conducting film to prevent heat loss in the reaction vessel, condensation of the sample, leakage due to vaporization of the sample, and the like. The hot lead is supported on the upper surface of the reaction vessel at a temperature of 90 to 130° C. The hot lid pressurizes the reaction vessel at a high temperature and pressure, thereby preventing the sample solution in the reaction vessel heated in the denaturation step from condensing. In addition, the hot lid pressurizes the reaction vessel at a high temperature and pressure, thereby preventing the sample solution in the reaction vessel sealed with a sealing means such as a cap or a sealing film from being vaporized and leaking to the outside.

The thermal block housing 110 accommodates the thermal block 101, the heat generating element 103 and the heat sink 104, and the like. The thermal block housing 110 has an open upper part, and the thermal block 101 is positioned on the open upper part. The thermal block housing 110 has open front and rear surfaces, and air is supplied to and discharged from the heat sink 104 through the open front and rear surfaces.

The heat dissipation fan 310 for supplying air to the heat sink 104 may be coupled to the thermal block housing 110 (see FIG. 3). The heat dissipation fan 310 may be coupled to any one of the open front and rear surfaces of the thermal block housing 110. The heat dissipation fan 310 may include one or more fan units, and each fan unit is coupled to the thermal block housing 110. As an example, the fan unit may be screwed to the thermal block housing 110. As air is supplied to the heat sink 104 by the heat dissipation fan 310, the heat generating element 103 is rapidly cooled by the heat sink 104.

The lower frame 113 may have an inclined surface 115 that is inclined to decrease in height on the side facing the heat dissipation fan 310 and on the opposite side thereof. The inclined surface 115 may be provided at the front and rear of the lower frame 113, respectively. The height of the lower frame 113 by the inclined surface 115 is disposed to decrease toward both ends from a flat surface in the center. As the inclined surface 115 is disposed, the gap between the upper surface of the lower frame 113 and the lower surface of the upper frame 111 becomes narrower toward the center of the thermal block housing 110. Accordingly, the air supplied from the heat dissipation fan 310 is concentrated on the heat sink 104 while passing the inclined surface 115, and the air may be rapidly discharged to the opposite side through the heat sink 104, thereby improving heat dissipation performance. The inclined surface 115 does not necessarily have to be provided with a constant inclination, and each inclined surface 115 may be provided with a plurality of different inclinations.

The thermal block housing 110 includes the lower frame 113, a side frame 112, and the upper frame 111. The lower frame 113, the side frame 112, and the upper frame 111 may each be provided in the form of a square plate.

The lower frame 113 is located at the lower side of the heat sink 104 and is provided with an upper surface facing the heat sink 104. The side frames 112 are provided as a pair and are coupled to face each other on both sides of the lower frame 113, and the side frames 112 may not be coupled to the front and rear surfaces of the lower frame 113. The upper frame 111 is provided as a pair or a pair of combined integrally and coupled to the side frame 112 with the thermal block 101 interposed therebetween at the front and rear.

The lower frame 113, the side frame 112, and the upper frame 111 may be screwed to each other by bolts. Although not shown in the drawing, the heat sink 104 may be screwed to the side frame 112.

The thermal block housing 110 is coupled to the support frame 130 by a fastening member 121 of a damping module 120. The fastening member 121 makes the lower frame 113 of the thermal block housing 110 to be coupled to the support frame 130.

The support frame 130 may be provided on the lower side of the thermal block housing 110, that is, provided on the lower side of the lower frame 113.

According to one embodiment of the present disclosure, the support frame 130 may be a bar shape. According to another embodiment of the present disclosure, the support frame 130 may have a case shape for accommodating the thermal block housing 110.

According to one embodiment of the present disclosure, the thermal cycler may further include a rail frame 320 coupled to the support frame 130 to provide a linear movement path to the thermal block housing 110 (see FIG. 3).

The linear movement path may be a horizontal direction, or may be a front-rear direction or a lateral direction. FIG. 3 shows an embodiment in which the rail frame 320 provides a linear movement path in the front-rear direction to the thermal block housing 110.

The rail frame 320 and the support frame 130 may have a bar shape long in a linear line. The rail frame 320 may be coupled to the lower surface of the support frame 130. The rail frame 320 may be provided to be longer than the support frame 130, and the length of the rail frame 320 may vary depending on the length of a linear movement path provided to the thermal block housing 110. The rail frame 320 may have a narrower width than the support frame 130, grooves disposed long in the longitudinal direction are provided on both sides of the rail frame 320, and a coupling member 330 engaged with the grooves of the rail frame 320 may be coupled to the support frame 130. The coupling member 330 has an upper surface coupled to the support frame 130, and a lower surface supported by the rail frame 320 is provided with a protrusion portion facing the rail frame 320 interposed therebetween. The protrusion inserted into the groove of the rail frame 320 is provided on the inner side surface of the protrusion portion, and the linear movement of the thermal block housing 110 is guided by the groove and the protrusion. The coupling member 330 may be screwed to the support frame 130.

A plurality of support frame 130 and rail frame 320 may be provided. According to one embodiment, the support frame 130 and the rail frame 320 are spaced apart from each other in a direction perpendicular to the linear direction and may be provided in plurality. Accordingly, the linear movement of the thermal block housing 110 may be stably supported. As shown in the drawings, the support frame 130 is provided on both sides in the lateral direction on the lower surface of the lower frame 113, and the rail frame 320 may be provided to be coupled to each support frame 130.

The damping module 120 elastically supports the thermal block housing 110 spaced apart from the support frame 130, as will be described later in detail, and the damping module 120 may be provided in plurality and spaced apart from each other in the linear direction of the support frame 130. For example, three damping modules 120 may be provided to be spaced apart between each support frame 130 and the lower frame 113. Accordingly, a total of six damping modules 120 are provided to stably support the lower surface of the thermal block housing 110. In one embodiment of the present disclosure, it is implemented that a total of six damping modules 120 are provided into two rows of three each so that the support frame 130 and the lower frame 113 are spaced apart.

The number of the damping modules 120 varied according to an embodiment of the present disclosure, and 2, 3, 4, 5, 6, 7, 8, 9 or 10 damping modules may be provided to be spaced apart between the support frame 130 and the lower frame 113. Therefore, a total of 4, 6, 8, 10, 12, 14, 16, 18 or 20 damping modules 120 may be provided to stably support the lower surface of the thermal block housing 110. The number of damping modules 120 varies according to an embodiment of the present disclosure, and the number of damping modules 120 provided may be different depending on the size and shape of the thermal block housing 110. In addition, the number of damping modules 120 varied according to an embodiment of the present disclosure, and the number of damping modules 120 provided according to the size and shape of the support frame 130 and the lower frame 113 may be different.

The thermal block housing 110 may be moved to the inside and the outside of the PCR device along a linear movement path provided by the rail frame 320. That is, when the thermal block housing 110 in which the thermal block 101 is accommodated is supported by the rail frame 320 and moved to the outside of the PCR device, the thermal block 101 is exposed to the outside. A user may place the reaction vessel in the thermal block 101 or withdraw the reaction vessel from the thermal block 101. When the thermal block housing 110 is moved to the inside of the PCR device, the thermal block housing 110 is located at the lower side of the optics mechanism for analyzing or monitoring the amplification reaction.

The linear movement of the thermal block housing 110 may be performed by the driving unit (not shown) that provides power to the support frame 130 in a linear direction. The driving unit may include a motor, a speed reducer, a screw, and the like, and is not limited as long as it may provide the power in the linear direction to the support frame 130. A driving fastening frame (not shown) coupled to each support frame 130 may be further provided, and the driving fastening frame may have a bar shape disposed in a direction perpendicular to each support frame 130. The driving unit may move the thermal block housing 110 by providing the power in the linear direction to the driving fastening frame.

The upper frame 111 is provided with a bush 114 into which the guide pin of the optics mechanism is inserted. A hole penetrating upward and downward is formed in the upper frame 111, and the bush 114 is inserted into the hole and coupled to the upper frame 111.

The hole is disposed in each upper frame 111 and the bush 114 may be inserted into and coupled to each hole, and the hole is disposed on opposite sides of each upper frame 111 and positioned in a diagonal direction. The guide pin is positioned to correspond to each bush 114.

The bush 114 and the guide pin may be formed of metal.

The bush 114 is hollow and the guide pin may be inserted into the bush 114 or separated from the bush 114. The guide pin protrudes downward from the lower part of the optics mechanism, and the tip may be tapered and pointed to be easily inserted into the bush 114.

Accordingly, as the thermal cycler 100 is positioned on the lower part of the optics mechanism and the optics mechanism are lowered at a position spaced from the thermal block 101, the guide pins are inserted into the bush 114 and the optics mechanism and the thermal block housing 110 is aligned with each other and fixed.

When the abrasion of the guide pin or bush 114 is accumulated due to friction generated when the guide pin is inserted into the bush 114, an error may occur in the alignment of the optics mechanism and the thermal block housing 110 by the guide pin and the bush 114. In an embodiment of the present disclosure, at least one damping module 120 is provided in order to minimize abrasion of the guide pin or bush 114.

The damping module 120 couples the thermal block housing 110 to the support frame 130 and elastically supports the thermal block housing 110 while spaced apart from the support frame 130.

The damping module 120 includes a fastening member 121 and an elastic member 122. The fastening member 121 is coupled to the thermal block housing 110 and the support frame 130, and the elastic member 122 is provided between the thermal block housing 110 and the support frame 130. The elastic member 122 elastically supports the thermal block housing 110 upward with respect to the support frame 130 and is spaced upwardly.

As an example, the fastening member 121 may be a bolt and the elastic member 122 may be a coil spring. The fastening member 121 may be positioned by being inserted into the elastic member 122.

The thermal block housing 110 is elastically supported by the elastic member 122 and is spaced upward from the support frame 130, and the fastening member 121 limits the separation distance at which the thermal block housing 110 is separated from the support frame 130. The fastening member 121 may prevent the thermal block housing 110 from being uncoupled or detached from the support frame.

That is, the damping module 120 provides a movable range in which the thermal block housing 110 may be moved upward and downward from the guide frame while the thermal block housing 110 and the support frame 130 are coupled to each other.

The thermal block housing 110 may be moved downward by the movable range provided by the damping module 120, so that friction between the guide pin and the bush 114 may be reduced. That is, when the optics mechanism is lowered in a state where the position of the guide pin does not exactly match the hollow of the bush 114, the friction generated by the guide pin pressing the bush 114 downward may be reduced.

When the guide pin presses the bush 114 downward, the elastic member 122 is compressed and the thermal block housing 110 is moved downward. The thermal block housing 110 moved downward is moved upward again by the elasticity of the elastic member 122, and accordingly, the bush 114 is accurately fitted to the guide pin, and the thermal block housing 110 and the optics mechanism are aligned with each other.

The optics mechanism is lowered and the hot lead presses the reaction vessel, and thus the elastic member 122 may support the thermal block housing 110 in a compressed state. Accordingly, only the elastic force of the elastic member 122 is applied to the reaction vessel, and the driving force of the driving device for elevating and lowering the optics mechanism does not act on the reaction vessel, thereby preventing the reaction vessel from being damaged. The damping module 120 is supported so as to be parallel to the non-horizontal hot lead and closely adhered to it even if the hot lead descends non-horizontally to pressurize the reaction vessel.

In addition, since the upper and lower movable ranges are provided in the thermal block housing 110, the reaction vessel may be protected from external shocks applied to the PCR device. That is, the elastic member 122 is compressed or stretched to cushion an impact from the outside, and accordingly, the thermal block housing 110 flows upward and downward, and the reaction vessel may be protected.

The fastening member 121 is inserted into and coupled to the first insertion hole 116 disposed in the lower frame 113 and the second insertion hole 131 disposed in the support frame 130.

According to one embodiment of the present disclosure, the first insertion hole 116 may be disposed to penetrate the lower frame 113 up and down.

According to another embodiment of the present disclosure, the second insertion hole 131 may be disposed to penetrate the support frame 130 up and down.

The first insertion hole 116 may include an accommodating portion 410 opened downward for accommodating the upper end of the elastic member 122. The elastic member 122 may have a lower end supported by the support frame 130 and an upper end supported by the lower frame 113, and the upper end may be inserted into the accommodating portion 410 and supported by the lower frame 113.

According to one embodiment of the present disclosure, the upper end of the elastic member 122 may be inserted into the accommodating portion 410, and supported by the support portion 420, provided in the lower frame 113, that is protruded from the inner peripheral surface of the first insertion hole 116. The lower end of the elastic member 122 may be supported on the upper surface of the support frame 130.

According to another embodiment of the present disclosure, the upper end of the elastic member 122 may be inserted into the accommodating portion 410 to be supported by the lower frame 113. The lower end of the elastic member 122 may be supported by the support portion 420 of the second insertion hole 131. The support portion 420 is provided in the support frame 130 and is disposed to protrude from the inner circumferential surface of the second insertion hole 131.

As the upper end of the elastic member 122 is accommodated in the accommodating portion 410 of the first insertion hole 116, the elastic member 122 may be provided to be penetrated by the fastening member 121. As an example, the elastic member 122 may be a coil spring, and the fastening member 121 may be a bolt passing through the coil spring and coupling the lower frame 113 and the support frame 130.

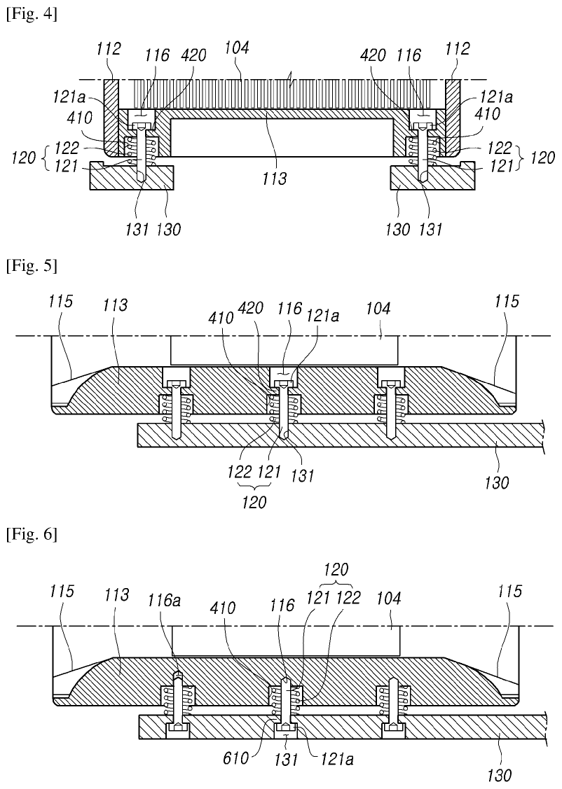

FIGS. 4 to 6 are cross-sectional views of a portion of a thermal cycler according to an embodiment of the present disclosure.

Referring to FIGS. 4 and 5, according to one embodiment of the present disclosure, the first insertion hole 116 is disposed to penetrate the lower frame 113 up and down, and the lower frame 113 is provided to be movable up and down with respect to the fastening member 121.

The fastening member 121 inserted into the lower frame 113 is coupled to the support frame 130 and fixed up and down, and the lower frame 113 is provided to be movable up and down with respect to the fastening member 121. Accordingly, a movable range in the up and down directions is provided to the thermal block housing 110.

The lower frame 113 is provided with the support portion 420 protruding from the inner circumferential surface of the first insertion hole 116, and the fastening member 121 includes a head portion 121a supported by the support portion 420 from the upper side. The head portion 121a is supported by the support portion 420, and the distance at which the thermal block housing 110 is spaced apart from the support frame 130 is limited. The body portion of the fastening member 121 is coupled to the support frame 130, and the head portion 121a is integrally connected to the upper side of the body portion. The head portion 121a may have a greater width or radius than the body portion, and thus the head portion 121a of the fastening member 121 inserted into the first insertion hole 116 may be supported by the support portion 420 at the upper side. As the support portion 420 protrudes from the inner circumferential surface of the first insertion hole 116, an upper portion of the first insertion hole 116 is opened upward and has a greater width or radius than the head portion 121a, a lower portion thereof is opened upward and has a greater width or radius than the elastic member 122, and the support portion 420 protrudes in the middle portion thereof.

The fastening member 121 may be screwed to the support frame 130. The body portion of the fastening member 121 is inserted into the second insertion hole 131 at the upper side and may be screwed. A screw portion is disposed on the outer surface of the portion inserted into the second insertion hole 131 of the body portion. The screw portion is not disposed on the outer surface of the portion of the body portion not inserted into the second insertion hole 131 and supported by the support portion 420. Accordingly, the lower frame 113 may be provided to be movable in the up and down directions by the fastening member 121 moving between the support 420 and the body.

In addition, when the lower frame 113 is moved up and down, the length of the fastening member 121 may be shorter than the sum of the depth of the first insertion hole 116 and the depth of the second insertion hole 131 so that the upper end of the fastening member 121 does not protrude upward from the upper surface of the lower frame 113. That is, when or before the lower frame 113 is moved to the lowermost side and is supported by the support frame 130, if the fastening member 121 protrudes upward from the first insertion hole 116, a collision with another configuration, for example, the heat sink 104 may occur. In order to prevent this collision, the length of the fastening member 121 may be shorter than the sum of the depth of the first insertion hole 116 and the depth of the second insertion hole 131.

Referring to FIG. 6, according to another embodiment of the present disclosure, the second insertion hole 131 is disposed to penetrate the support frame 130 up and down, and the fastening member 121 is provided to be movable up and down with respect to the support frame 130.

The fastening member 121 is coupled to the lower frame 113 and fixed, and the fastening member 121 is movably coupled up and down with respect to the inserted support frame 130, the lower frame 113 and The fastening member 121 may move up and down with respect to the support frame 130 to provide the thermal block housing 110 with a movable range in the up and down directions.

The support frame 130 is provided with a support portion 610 protruding from the inner circumferential surface of the second insertion hole 131, and the fastening member 121 includes a head portion 121a supported by the support portion 610 from the lower side. The head portion 121a is supported by the support portion 610, and the distance at which the thermal block housing 110 is spaced apart from the support frame 130 is limited. The body portion of the fastening member 121 is coupled to the lower frame 113, and the head portion 121a is integrally connected to the upper side of the body portion. The head portion 121a may have a greater width or radius than the body portion, and thus may be supported by the support portion 610 from the lower side. As the support portion 610 protrudes from the inner circumferential surface of the second insertion hole 131, the lower portion of the second insertion hole 131 is opened downward and has a greater width or radius than the head portion 121a, and the support portion 610 protrudes in the upper portion thereof. The upper surface of the support frame 130 is depressed, and the second insertion hole 131 may further include an accommodating portion in which the lower end of the elastic member 122 is accommodated.

The fastening member 121 may be screwed to the lower frame 113. The body portion of the fastening member 121 is inserted into the first insertion hole 116 from the lower side and may be screwed. A screw portion is disposed on the outer surface of the portion inserted into the first insertion hole 116 of the body portion. The screw portion is not disposed on the outer surface of the portion of the body portion not inserted into the second insertion hole 131 and supported by the support portion 420. Accordingly, the lower frame 113 may be provided to be movable in the up and down directions by the fastening member 121 moving between the support portion 610 and the body.

In addition, when the fastening member 121 is moved up and down, the length of the fastening member 121 is the first insertion hole may be shorter than the sum of the depth of the first insertion hole 116 and the depth of the second insertion hole 131 so that the lower end of the fastening member 121 does not protrude downward the lower surface of the support frame 130. That is, when or before the fastening member 121 is moved to the lowermost side and the lower frame 113 is supported by the support frame 130, if the fastening member 121 protrudes downward from the second insertion hole 131, a collision with another configuration, for example, the rail frame 320 may occur. In order to prevent this collision, the length of the fastening member 121 may be shorter than the sum of the depth of the first insertion hole 116 and the depth of the second insertion hole 131.

Meanwhile, at least one of the damping modules 120 may be provided to adjust the depth at which the fastening member 121 is coupled to the thermal block housing 110 or the support frame 130. That is, at least one of the fastening members 121 may be provided to adjust a depth at which they are coupled to the first insertion hole 116 or a depth which they are coupled to the second insertion hole 131. The depth at which the at least one fastening member 121 is coupled may be adjusted, and the thermal block housing 110 may be adjusted to be horizontal. As the thermal block housing 110 becomes horizontal, the guide pin may be accurately inserted into the bush 114 to reduce friction. In addition, since the surface of the reaction vessel may be accurately surface-contacted with the hot lead, the load is uniformly applied to the reaction vessel and is not concentrated on a specific area, thereby preventing damage.

According to an embodiment of the present disclosure, at least one of the fastening members 121 may be provided to adjust the depth at which they are coupled to the first insertion hole 116. As a plurality of damping modules 120 are provided, the first insertion hole 116 and the second insertion hole 131 into which each fastening member 121 is inserted are provided at corresponding positions in the lower frame 113 and the support frame 130, respectively. and the depth of at least one of the first insertion holes 116 may be disposed to be deeper than the depth of the remaining first insertion holes 116 (refer to reference numeral 116a). When each support frame 130 is coupled to the lower frame 113 by three damping modules 120, the two first insertion holes 116 are disposed to have the same depth, but the remaining first insertion hole 116 is disposed deeper than these. The fastening member 121 is inserted to the end and coupled to the first insertion hole 116 having the same depth, and as the other first insertion hole 116 is disposed deeper than that, the fastening member 121 is not inserted to the end and coupled more deeply or more shallowly.

For example, the remaining first insertion hole 116 may be provided on the front end side of the lower frame 113. The remaining first insertion hole 116 may be the first insertion hole 116 provided on the most front side. When the two support frames 130 are coupled to the lower frame 113 by three damping modules 120 spaced apart from each other in the front and rear directions, the two first insertion holes 116 into which the fastening member 121 of the damping module 120 provided at the front most side is inserted may be disposed deeper than the remaining four first insertion holes 116. The user may screw the fastening member 121 located at the front more deeply or shallowly. When the thermal block housing 110 is moved by the driving unit and exposed to the outside of the PCR device, the user may adjust the depth at which the fastening member 121 is coupled to the corresponding first insertion hole 116 through the lower side of the support frame 130. In this case, the user may adjust the depth at which the fastening member 121 provided at the front end of the support frame 130 is coupled to the corresponding first insertion hole 116.

According to another embodiment of the present disclosure, at least one of the fastening members 121 may be provided to adjust the depth at which they are coupled to the second insertion hole 131. The depth of at least one of the second insertion holes 131 may be disposed to be greater than the depth of the other second insertion holes 131. When each support frame 130 is coupled to the lower frame 113 by the three damping modules 120, the two second insertion holes 131 are disposed to have the same depth and the remaining one second insertion hole 131 may be disposed deeper than that. The fastening member 121 is inserted to the end and coupled to the second insertion hole 131 having the same depth, and as the other second insertion hole 131 is disposed deeper than one, the fastening member 121 is not inserted to the end is coupled more deeply or more shallowly.

The user may adjust the thermal block housing 110 to be horizontal by screwing the depth-adjustable fastening member 121 more deeply or more shallowly. In addition, when an error occurs in the elastic force of one or more elastic members among the plurality of elastic members and the elastic force of other elastic members, the user may screw the depth-adjustable fastening member 121 more deeply or more shallowly, thereby reducing the error of the elastic members.

The depth into which the fastening member 121 is inserted may be adjusted by the hole disposed in the first insertion hole 116 or the second insertion hole 131 in one embodiment or another embodiment of the present disclosure as mentioned above. At this time, the number of the first insertion hole 116 or the second insertion hole 131 enabling the adjustment of the depth into which the fastening member 121 is inserted may be implemented to be the same as the number of the damping module 120, or implemented less than the number of the damping module 120. For example, when the number of damping modules 120 is 6, the number of the first insertion hole 116 or the second insertion hole 131 enabling the adjustment of the depth may be 1, 2, 3, 4, 5 or 6. However, since the support frame 130 is provided in a linear direction on both sides of the lower frame 113, The number of the first insertion hole 116 or the second insertion holes 131 enabling the adjustment of the depth may be provided in an even number such as 2, 4, or 6.

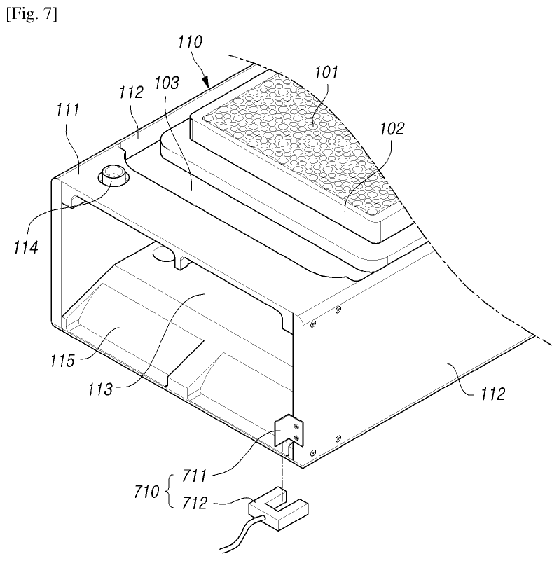

FIG. 7 is a perspective view of a thermal cycler according to an embodiment of the present disclosure.

Referring to FIG. 7, the thermal cycler 100 includes a sensor module 710 that generates a signal when the separation distance between the thermal block housing 110 and the support frame 130 is less than or equal to a predetermined distance.

That is, as the optics mechanism is lowered by the driving device, the hot lead is supported by the reaction vessel and the thermal block housing 110 is moved downward. In this case, since the elastic force of the elastic member 122 is applied to the reaction vessel, the sensor module 710 is provided to limit the load applied to the reaction vessel and stop the lowering of the optics mechanism.

The signal transmitted by the sensor module 710 stops the driving device for raising and lowering the optics mechanism. For example, when the signal is transmitted to a controller that controls the driving device, and the controller receives the signal of the sensor module 710, the lowering of the driving device may be stopped.

The thermal block 101 may accommodate the reaction vessels having various sizes and heights, but the reaction vessels simultaneously accommodated in the thermal block 101 in order to perform the amplification reaction must be configured to have the same size and height as each other so that the hot lid may be supported on the top surface of the reaction vessel. On the other hand, the reaction vessels having different sizes and heights may be accommodated in the thermal block 101 in different amplification reactions.

In one embodiment, a high sized reaction vessel may be inserted into the thermal block 101, and in another embodiment a low sized reaction vessel may be inserted into the thermal block 101. Even if the reaction vessels of different heights are accommodated in each amplification reaction, the sensor module 710 is operated by the pressure that the hot lead presses while supporting the upper surface of the reaction vessel. Accordingly, the hot lead may provide the same pressure to the reaction vessels of different heights, and the sensor module 710 may measure the movement of the thermal block housing 110 with respect to the pressure at which the hot lead lowers, and generate a signal that may stop the lowering.

The sensor module 710 includes a tab 711 and a sensor 712. The tab 711 may be provided in the thermal block housing 110 and the sensor 712 may be located in the movement path of the tap 711. When the thermal block housing 110 is moved upward or downward, the tab 711 is moved together in a state at which it is coupled to the thermal block housing 110, and the sensor 712 is fixed with respect to the support frame 130 and the tab 711 is located in the movement path. The sensor 712 may be coupled to the driving fastening frame. The sensor module 710 may be provided on the rear surface of the thermal cycler 100. The tab 711 may be coupled to the rear surface of the thermal block housing 110 and may be located on the opposite side of the heat dissipation fan 310.

The sensor 712 may be provided in a U-shape, and the receiver and the transmitter may be provided to face each other. The transmitter emits an optical signal toward the receiver, and the receiver receives the emitted optical signal. As the thermal block housing 110 lowers, the tab 711 moves from the upper side to the lower side and is inserted between the receiver and the transmitter to block the optical signal, the sensor 712 generates a signal.

The shape of the tab 711 is not limited, however, as shown in the drawings, it is provided in a L-shape so that one end is coupled to the side frame 112 and the other end may protrude rearward. The other end protruding to the rear of the tab 711 is inserted between the receiver and the transmitter to block the optical signal.

It will be understood that the terms “comprise”, “include”, “have”, and any variations thereof used herein are intended to cover non-exclusive inclusions unless explicitly described to the contrary. Unless otherwise specified, all terms including technical and scientific terms used herein have the same meaning as that commonly understood by those having ordinary knowledge in the technical field to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The above description and the accompanying drawings provide an example of the technical idea of the present disclosure for illustrative purposes only. Those having ordinary knowledge in the technical field, to which the present disclosure pertains, will appreciate that various modifications and changes in form, such as combination, separation, substitution, and change of a configuration, are possible without departing from the essential features of the present disclosure. Therefore, the embodiments disclosed in the present disclosure are intended to illustrate the scope of the technical idea of the present disclosure, and the scope of the present disclosure is not limited by the embodiment. The scope of the present disclosure shall be construed on the basis of the accompanying claims in such a manner that all of the technical ideas included within the scope equivalent to the claims belong to the present disclosure.

The foregoing detailed descriptions of specific exemplary embodiments of the present disclosure have been and are not intended to be exhaustive or to limit the present disclosure to the precise forms disclosed, and obviously a number of modifications and variations are possible for those having ordinary knowledge in the art in light of the above teachings. It is intended therefore that the scope of the present disclosure not be limited to the foregoing embodiments, but be defined by the Claims appended hereto and their equivalents.

### CROSS-REFERENCE TO RELATED APPLICATIONS

This application claims priority from Korean Patent Application No. 10-2020-0096253, filed on Jul. 31, 2020, in the Korean Intellectual Property Office, the disclosure of which is incorporated herein by reference in its entirety.

1. A thermal cycler comprising:
a thermal block housing comprising a thermal block accommodating a reaction vessel and a temperature control portion for controlling a temperature of the thermal block;
a support frame provided at the lower side of the thermal block housing; and
at least one damping module comprising a fastening member coupled to the thermal block housing and the support frame and an elastic member provided between the thermal block housing and the support frame and elastically supporting the thermal block housing while spaced apart from the support frame.

2. The thermal cycler of claim 1, wherein the thermal block housing comprises a lower frame coupled to the fastening member and an upper frame in which the thermal block is accommodated.

3. The thermal cycler of claim 2, wherein the fastening member is inserted into and coupled to the first insertion hole in the lower frame and the second insertion hole in the support frame.

4. The thermal cycler of claim 3, wherein the first insertion hole comprises a first accommodating portion opened downward for accommodating the upper end of the elastic member.

5. The thermal cycler of claim 3, wherein the second insertion hole comprises a second accommodating portion opened upward for accommodating the lower end of the elastic member.

6. The thermal cycler of claim 3, wherein the elastic member is provided to be penetrated by the fastening member.

7. The thermal cycler of claim 3, wherein the first insertion hole is provided to penetrate the lower frame up and down, and the lower frame is provided to be movable up and down with respect to the fastening member.

8. The thermal cycler of claim 7, wherein the lower frame comprises a support portion protruding from the inner circumferential surface of the first insertion hole, and the fastening member comprises a head portion supported by the support portion at an upper side of the first insertion hole.

9. The thermal cycler of claim 7, wherein the fastening member is screwed to the support frame.

10. The thermal cycler of claim 3, wherein the second insertion hole is provided to penetrate the support frame up and down, and the fastening member is provided to be movable up and down with respect to the support frame.

11. The thermal cycler of claim 10, wherein the support frame comprises a support portion protruding from the inner circumferential surface of the second insertion hole, and the fastening member comprises a head portion supported by the support portion at the lower side of the second insertion hole.

12. The thermal cycler of claim 11, wherein the fastening member is screwed to the lower frame.

13. The thermal cycler of claim 1, wherein the damping module is provided in a plurality.

14. The thermal cycler of claim 1, wherein at least one of the damping modules is provided to adjust the separation distance by adjusting the depth at which the fastening member is coupled to the thermal block housing or the support frame.

15. The thermal cycler of claim 1, further comprising:
a rail frame coupled to the support frame to provide a linear movement path to the thermal block housing.

16-17. (canceled)

18. The thermal cycler of claim 15, wherein a driving unit for providing power in the linear direction is connected to the support frame.

19. The thermal cycler of claim 1, further comprising:
a sensor module for generating a signal when the distance between the thermal block housing and the support frame is less than or equal to a predetermined distance.

20. The thermal cycler of claim 19, wherein the sensor module comprises a tab provided in the thermal block housing and a sensor positioned in a movement path of the tab,
the sensor is provided with a receiving portion and a transmitting portion facing each other, and
the tab is inserted between the receiving portion and the transmitting portion as the thermal block housing is lowered.

21. The thermal cycler of claim 1, wherein the thermal block housing is provided with a heat dissipation fan for supplying air to the thermal block through a space between an upper frame and a lower frame.

22. The thermal cycler of claim 21, wherein the lower frame is provided with an inclined surface that is inclined to lower the height on the side facing the heat dissipation fan and the opposite side.
